(19) United States
(12) Patent Application Publication
(10) Pub. No.: US 2023/0321623 A1
(43) Pub. Date: Oct. 12, 2023

(54) TUBULAR REACTORS

(71) Applicant: UNISA, Pretoria (ZA)

(72) Inventors: Jianqi SHEN, Pretoria (ZA); Xinying LIU, Pretoria (ZA); Diane HILDEBRANDT, Pretoria (ZA)

(21) Appl. No.: 18/024,464

(22) PCT Filed: Sep. 2, 2021
(86) PCT No.: PCT/IB2021/058001

§ 371 Date: Mar. 2, 2023

(30) Foreign Application Priority Data
Sep. 2, 2020 (GB) 2013769.1

(51) Int. Cl. B01J 8/06; B01J 19/18; B01J 8/00

(52) U.S. Cl. CPC B01J 8/06; B01J 19/1812; B01J 8/0015; B01J 2208/0038

(57) ABSTRACT

The invention relates to tubular reactors. In particular the invention provides for a reactor internal component for a fixed bed reactor which is axially receivable within a portion of an internal reaction cavity of a reactor tube. The reactor internal component includes a tubular insert, having a tubular wall with an outer surface shaped and dimensioned to fit into the internal reaction cavity of the reactor tube, the tubular insert having an inner passage of varied diameter which is operable to change a profile of the internal reaction cavity, in use to improve temperature distribution in a catalyst bed provided within the internal reaction cavity of the reactor tube.

### FIELD OF THE INVENTION

This invention relates to tubular reactors. In particular, the invention relates to a reactor internal component for a fixed bed reactor, a reactor tube for use in a fixed bed reactor, and a method of installing a reactor internal component in a reactor tube of a fixed bed reactor.

### BACKGROUND OF THE INVENTION

A tubular fixed bed reactor (TFBR) is one of the most successful types of reactors which is widely used in multi-scale applications in academia and industry. The TFBR's merits include a simple installation and operation; a high catalyst loading volume; a high potential productivity; and an easy scale up.¹ However, the TFBR's shortcomings (including a low heat transfer capacity, high pressure drops and a high capital investment) cannot be ignored when considering the TFBR's application.²

In strongly exothermic processes, such as a Fischer-Tropsch Synthesis (FTS), the TFBR's intrinsic characteristics of poor heat removal may result in a hot spot forming in a catalyst bed.^{3 4} An undesirable temperature rise, which may lead to catalyst deactivation—a negative effect on target product selectivity—and even temperature runaway, can easily occur in the TFBR during exothermic processes.⁵ However, the TFBR still has a significant role in multi-scale FTS applications, since its successors—a fluidized bed reactor, a slurry bed reactor, etc—have their own limitations.

Many strategies to improve heat transfer during exothermic processes in the TFBR have been proposed, with the aim of reducing or eliminating a temperature gradient in the catalyst bed. Structured catalysts have a superior heat removal capacity compared to a conventional pellet or a powdered catalyst bed, and also offer advantages, such as a lower pressure drop, a better mass transfer, etc.^{6 7} The structured catalyst normally consists of a pre-shaped ceramic or a metallic supports with active components that are coated or deposited on a support, for example a honeycomb monolith catalysts and a metal foam catalysts, etc.^{8 9}

Merino and his colleagues prepared a metallic monolith catalyst by coating a Co—Re/Al₂O₃ catalyst on foils of different alloys and testing it under typical low temperature FTS conditions.¹⁰ The results obtained indicate that, although the temperature inside the aluminum monolith catalyst was difficult to measure, it could be inferred that isothermal operation is considered to have been achieved since the adverse effects on methane selectivity caused by temperature rise were not significant under the various operating conditions tested.

The use of an open-cell aluminum foam catalyst loaded with the Co—Pt/Al₂O₃ which was employed in a tubular FT reactor was reported by Fratalocchi.¹¹ The performance of the reactor was outstanding, even under the most severe operating conditions. However, disadvantages, have been widely reported in the literature, including that: a) loading of catalyst per reactor volume is lower than that in a randomly packed catalyst bed; b) preparing a structured catalyst is complex and costly; c) dispersion of the active component is difficult to control; d) pilot and even larger scale applications are not well reported and thus there is a lack of practical operational experience.^{9 12 13}

Another approach used to intensify heat transfer across a tubular reactor wall is to increase the heat exchange area by constructing projecting fins.^{14 15} Bhouri et al. investigated the effects of the geometric properties of the fins (such as the number of fins, thickness and tip clearance), on the hydrogen charging rate, using a multi-tubular sodium alanate hydride reactor.¹⁶ In their simulation results, the temperature distribution was significantly improved with an optimized fin configuration, and an increase of 41% in hydrogen loading rate was achieved. However, the total mass increase and the loss of volumetric efficiency of the multi-tube reactor, due to the presence of fins, should not be ignored. Thus, although an isothermal operation can be achieved by fabricating fins on a reactor wall, some sacrifices on reactor performance have to be made. For instance, the loading volume of a catalyst as well as a potential productivity declined due to the presence of fins in a catalyst bed. Consequently, there was a significant loss in a volumetric efficiency of a multi-tube reactor when fins were used on an outer wall of a reactor tube.

Reactor internals are mechanical parts that are assembled or placed inside of a reactor in order to achieve certain functions or improve reactor performance. In order to intensify the heat transfer rate in a conventional catalyst bed, the use of reactor internals on an inside of a reactor tube was considered a good compromise between attempting to improve heat transfer in a fixed bed reactor and avoiding new problems as mentioned in above cited literatures.

Porta reported catalytic reactor internals with a bent and a folded structure, which functioned as a thermal conductor between the catalyst bed and a heat sink, in order to maintain the isothermal operation in an exothermic reaction system.¹⁷ Hartvigsen proposed reactor internals that consist of a plurality of fins with catalyst particles packed amongst them.¹⁸ Its outstanding performance in controlling temperature in both a radial and an axial direction was verified in a 3/2″ diameter FTS reactor. Verbist reported that an “insert”, which is a type of reactor internal, can act as a conductor in the FTS reactor tube and directly remove the reaction heat.¹⁹ Other researchers proposed other kinds of reactor internals that help control temperature, although they were originally designed for different purposes, i.e. intensifying mass transfer, improving fluid flow, etc.²⁰ Anton et al reviewed different fixed bed reactor internals applied in a hydrogenation process for oil fractions, and concluded that the internal hardware of the reactor (a distributor tray, a quench box, etc.) can promote the reactant flow distribution, as well as reduce the temperature gradient in the catalyst bed²¹. Narataruksa et al employed the Kenics™ static mixer insert (commercialized reactor internals) in a tubular FTS reactor for the purpose of overcoming heat and mass transfer limitations.²² The results of the experiments showed that a hot spot formation in the catalyst bed was suppressed and a chain growth probability increased from 0.89 to 0.92 because the temperature in the catalyst bed was better controlled. Although it has shown that reactor internals in a TFBR can improve temperature control, limited progress has been made on developing and optimizing the design of such reactor internals. Related reported studies on reactor internals, especially those focusing on heat transfer, are rather limited. Thus, there is still a great deal of interest and innovation in designing reactor internals, which could reduce the temperature gradients in catalyst beds in an FTS process, especially if it can be used directly and easily in existing TFBR applications.

The inventor is aware of existing TFBRs and has identified a need to inhibit hot spot formation in a TFBR, by incorporating a new reactor internal component, thereby improving the temperature distribution associated with a catalyst bed, typically used in a highly exothermic reaction. The inventor aims to address this need with this invention.

In this specification, the term “reactor tube” refers to the tube in a fixed bed reactor or in a multi-tubular fixed bed reactor, in which the reaction takes place, also known as reaction tube, tube reactor, vertical tube or the like.

In this specification, reference is made to the following sources:

(1) Schultz, H. 1999. Short History and Present Trends of Fischer-Tropsch Synthesis. Appl. Caral. A Gen. 186 (1-2), 3-12.
(2) Davies, B. H. 2005. Fischer-Tropsch Synthesis: Overview of Reactor Development and Future Potentialities. Top. Catal. 32 (2-4), 143-168.
(3) Glasser, D., Hildebrandt, D., Liu, X., Lu, X. & Masuku, C. M. 2012. Recent Advances in Understanding the Fischer-Tropsch Synthesis (FTS) Reaction. Curr. Opin. Chem. Eng. 1 (3), 296-302.
(4) Zhu, X., Lu, X., Liu, X., Hildebrandt, D. & Glasser, D. 2014. Heat Transfer Study with and without Fischer-Tropsch Reaction in a Fixed Bed Reactor with TiO₂, SiO₂, and SiC Supported Cobalt Catalyst. Chem. Eng. J. 247, 75-84.
(5) Merino, D., Sanz, O. & Montes, M. 2017. Effect of Catalyst Layer Macroporosity in High-Thermal-Conductivity Monolithic Fischer-Tropsch Catalysts. Fuel. 210 (June), 49-57.
(6) Govender, S. & Friedrich, H. B. 2017. A Review of the Basics, Preparation Methods and Their Relevance to Oxidation. Catalysts. 7(2).
(7) Nijuis, T. A., Beers, A. E. W., Vergunst, T., Hoe, I., Kapteijn, F. & Moulijn, J. A. 2001. Preparation of Monolithic Catalysts. Catal. Rev-Sci. Eng. 43 (4), 345-380.
(8) Chin, Y. H., Hu, J., Cao, C., Gao, Y. & Wang, T. 2005. Preparation of a Novel Structured Catalyst Based on Aligned Carbon Nanotube Arrays for a Microchannel Fischer-Tropsch Synthesis reactor. Catal. Today. 110 (1-2), 47-52.
(9) Tronconi, E., Groppi, G. & Visconti, C. G. 2014. Structured catalyst for Non-Adiabatic Applications. Curr. Opin. Chem. Eng. 5, 55-67.
(10) Merino, D., Sanz, O. & Montes, M. 2017. Effect of the Thermal Conductivity and Catalyst Layer Thickness on the Fischer-Tropsch Synthesis Selectivity Using Structured Catalysts. Chem. Eng. J. 327, 1003-1042.
(11) Fratalocchi, L., Visconti, C. G., Groppi, G., Lietti, L. & Tronconi, E. 2018. Intensifying Heat Transfer in Fischer-Tropsch Tubular Reactor through the Adoption of Conductive Packed Foams. Chem. Eng. J. 349 (March), 829-837.
(12) Tomašić, V. & Jović, F. 2006. State-of-the-Art in the Monolithic Catalysts/Reactor. Appl. Catal. A Gen. 311 (1-20, 112-121.
(13) Lefevere, J., Mullens, S., Meynen, V. & Van Noyen, J. 2014. Structured Catalysts for Methanol-to-Olefins Conversion. A Review. Chem. Pap. 68 (9), 1143-1153.

### (14) Examiiner, P. & Caldarola, G. 2013. High Heat Transfer Tubular Reactor. 7018591 B2.

(15) Bruegger, E. 1957. Catalyst Finned Tubing and Method of Making. U.S. Pat. No. 2,778,610.
(16) Bhouri, M., Goyette, J., Hardy, B. J. & Anton, D. L. 2012. Numerical Modeling and Performance Evaluation of Multi-Tubular Sodium Alanate Hydride Finned Reactor. Int. J. Hydrogen Energy. 37 (2), 1551-1567.
(17) Porta, P. Della, Giorgi, T. A., Ferrario, C & Montalenti, P. 1974. Catalyst Cartridge. U.S. Pat. No. 3,857,680.
(18) Hartvigsen, J. J. 2014. Fixed Bed Reactor Heat Transfer Structure. US 2014/0134067 A1.
(19) Verbist, M. 2007. Tubular Reactor with Packing. US 2007/0299148 A1.
(20) Jin, B., Broekhuis, R. R., He, X., Nataraj, S., Licht, W. R. & Garg, D. 2012. Designated Extension States. Ep 2 514 523 A1
(21) Alvarez, A., Ramirez, S., Ancheyta, J. & Rodriguez, L. 2007. Key Role of Reactor Internals in Hydroprocessing of Oil Fractions. Energy and Fuels. 21 (3), 1731-1740.
(22) Narataruksa, P., Tungkamani, S., Pana-Suppamassadu, K., Keeratiwintakorn, P., Nivitchanyong, S., Hunpinyo, P., Sukkathanyawat, H., Jiamrittiwong, P. & Nopparat, V. 2012. Conversion Enhancement of Tubular Fixed-Bed Reactor for Fischer-Tropsch Synthesis Using Static Mixer. J. Nat. Gas Chem. 21 (4), 435-444.
(23) Jess, A.; Popp, R.; Hedden, K. Fischer-Tropsch-Synthesis with Nitrogen-Rich Syngas: Fundamentals and Reactor Design Aspects. Appl. Catal. A Gen. 1999, 186 (1-2), 321-342.
(24) Irani, M. Investigating the Production of Liquid Fuels from Synthesis Gas (CO+H2) in a Bench-Scale Packed-Bed Reactor Based on Fe-Cu-La/SiO₂ Catalyst: Experimental and CFD Modeling. Int. J. Ind. Chem. 2014, 5 (1), 1-9.
(25) Taniewski, M.; Lachowicz, A.; Skutil, K.; Czechowicz, D. Heat-Transfer Characteristics in Oxidative. Chem. Eng. Sci. 1996, 51 (96), 4271-4278.
(26) Chabot, G.; Guilet, R.; Cognet, P.; Gourdon, C. A Mathematical Modeling of Catalytic Milli-Fi Xed Bed Reactor for Fischer-Tropsch Synthesis : In Fl Uence of Tube Diameter on Fischer Tropsch Selectivity and Thermal Behavior. Chem. Eng. Sci. 2015, 127, 72-83.
(27) Todic, B.; Mandic, M.; Nikacevic, N.; Bukur, D. B. Effects of Process and Design Parameters on Heat Management in Fixed Bed Fischer-Tropsch Synthesis Reactor. Korean J. Chem. Eng. 2018, 35 (3), 1-15.
(28) Wang, Y. N.; Xu, Y. Y.; Li, Y. W.; Zhao, Y. L.; Zhang, B. J. Heterogeneous Modeling for Fixed-Bed Fischer-Tropsch Synthesis: Reactor Model and Its Applications. Chem. Eng. Sci. 2003, 58 (3-6), 867-875.
(29) Kshetrimayum, K. S.; Jung, I.; Na, J.; Park, S.; Lee, Y.; Park, S.; Lee, C. J.; Han, C. CFD Simulation of Microchannel Reactor Block for Fischer-Tropsch Synthesis: Effect of Coolant Type and Wall Boiling Condition on Reactor Temperature. Ind. Eng. Chem. Res. 2016, 55, 543-554.
(30) Jess, A.; Kern, C. Modeling of Multi-Tubular Reactors for Fischer-Tropsch Synthesis. Chem. Eng. Technol 2009, 32 (8), 1164-1175.
(31) Foumeny, E. A.; Benyahia, F. Predictive Characterization of Mean Voidage in Packed Beds. Heat Recover. Syst. CHP 1991, 11 (2-3), 127-130.
(32) Kshetrimayum, K. S.; Jung, I.; Na, J.; Park, S.; Lee, Y.; Park, S.; Lee, C. J.; Han, C. CFD Simulation of Microchannel Reactor Block for Fischer-Tropsch Synthesis: Effect of Coolant Type and Wall Boiling Condition on Reactor Temperature. Ind. Eng. Chem. Res. 2016, 55 (3), 543-554.
(33) Ansys Inc. Ansys Fluent 12.0 User's Guide; 2009.
(34) Philippe, R.; Lacroix, M.; Dreibine, L.; Pham-Huu, C.; Edouard, D.; Savin, S.; Luck, F.; Schweich, D. Effect of Structure and Thermal Properties of a Fischer-Tropsch Catalyst in a Fixed Bed. Catal. Today 2009, 147 (SUPPL.), S305-S312.
(35) Yates, I. C.; Satterfield, C. N. Intrinsic Kinetics of the Fischer-Tropsch Synthesis on a Cobalt Catalyst. Energy & Fuels 1991, 5 (1), 168-173.
(36) Sadeqzadeh, M.; Hong, J.; Fongarland, P.; Curulla-Ferre, D.; Luck, F.; Bousquet, J.; Schweich, D.; Khodakov, A. Y. Mechanistic Modeling of Cobalt Based Catalyst Sintering in a Fixed Bed Reactor under Different Conditions of Fischer-Tropsch Synthesis. Ind. Eng. Chem. Res. 2012, 51 (37), 11955-11964.
(37) Rafiq, M. H.; Jakobsen, H. A.; Schmid, R.; Hustad, J. E. Experimental Studies and Modeling of a Fixed Bed Reactor for Fischer-Tropsch Synthesis Using Biosyngas. Fuel Process. Technol. 2011, 92 (5), 893-907.
(38) Majidian, N.; Soltanali, S. Comparison of Fischer-Tropsch Fixed and Monolith Bed Reactors Using Pseudo-Homogeneous 2D Model. J. Japan Pet. Inst. 2016, 59 (4), 126-139.
(39) Montebelli, A.; Giorgio, C.; Groppi, G.; Tronconi, E.; Kohler, S. Optimization of Compact Multitubular Fixed-Bed Reactors for the Methanol Synthesis Loaded with Highly Conductive Structured Catalysts. Chem. Eng. J. 2014, 255, 257-265.

### SUMMARY OF THE INVENTION

Broadly according to a first aspect of the invention there is provided a reactor internal component for a fixed bed reactor, axially receivable within a portion of an internal reaction cavity of a reactor tube, which includes
a tubular insert, having a tubular wall with an outer surface shaped and dimensioned to fit into the internal reaction cavity of the reactor tube, the tubular insert having an inner passage of varied diameter which is operable to change a profile of the internal reaction cavity, in use to improve temperature distribution in a catalyst bed provided within the internal reaction cavity of the reactor tube.

The fixed bed reactor may be in the form of a multi-tubular fixed bed reactor.

The diameter of the outer surface of the tubular wall may be constant throughout the length of the tubular insert. The tubular wall may be of varying thickness to provide the varied diameter of the inner passage.

The reactor internal component may be axially receivable within a reactor tube.

The change in the profile of the internal reaction cavity includes decreasing an internal diameter of the internal reaction cavity in at least a portion of the reactor tube. The reactor internal component is operable to narrow the passage (internal reaction cavity) in the reactor tube, thereby decreasing heat build-up and resulting in more heat being removed when an exothermic reaction takes place in the reactor. As the internal reaction cavity is operable to receive catalyst particles to provide the catalyst bed, decreasing the internal diameter decreases the amount of catalyst particles receivable in that portion of the reactor tube.

The outer surface of the tubular insert may be cylindrical-shaped. The tubular insert may include an inner surface with a diameter smaller than the reactor tube. The diameter of the inner surface may be varied across the axial length of the tubular insert, in use changing an effective diameter of the internal reaction cavity.

The tubular insert may include one or more components selected from: ring components, annular components, tubular shaped components or the like.

The tubular insert may be in the form of an elongate tube. The reactor internal component may be of unitary construction or may be assembled from a plurality of parts.

The outer surface of the tubular insert may have an outer diameter which may match or be slightly less that the diameter of the reactor tube in which it is to be installed, such that the reactor internal component fits snugly into the reactor tube.

The reactor internal component may be operable to change the profile of the internal reaction cavity at the functional tube portion, to a conical frustum cavity or the like. The changed profile of the internal reaction cavity will be dependent on the type of gradual increase in diameter of the inner passage of the tubular insert, and is thus not limited to a conical frustum cavity.

The tubular insert may be operable to be placed at an upstream section (inlet, initial, entrance) of the catalyst bed in the reactor tube. Advantageously, this upstream section may be prone to hot spots, in use, the tubular insert reducing the temperature at the local position within the reactor tube.

The tubular insert may be operable to reduce the rate of release of reaction heat in an initial part of catalyst bed by distributing the reaction heat over a longer axial distance.

The reactor internal component may have two ends, a first end operable to be positioned before a second end, relative to the direction of flow in the multi-tubular fixed bed tubular reactor, such that the flow is from the first end to the second end. In use, the first end will be positioned above the second end.

The tubular insert may have a neck portion positioned between the two ends. The neck portion may be defined at the position (point or part) where the inner diameter of the inner passage is the smallest. The neck portion may have an inner diameter of approximately 10% to 90% of an inner diameter of the internal reaction cavity of the reactor tube. In particular, the inner diameter at the neck portion may be between 30% and 50% of the inner diameter of the reactor tube. More particularly, the inner diameter at the neck portion may be between 40% and 50% of the inner diameter of the reactor tube.

The neck portion may separate the tubular insert into a funnel portion and a functional tube portion. The funnel portion may be defined by a section of the tubular insert between the first end and the neck portion. The functional tube portion may be defined by a section of tubular insert between the neck portion and the second end.

The funnel portion may be operable to function as a draft tube for gaseous reactants which affects the flow dynamics and pressure drop of the catalyst bed.

The funnel portion may form a constriction from the internal reaction cavity on a first end of the reactor tube, in which a ceramic ball layer may be disposed, to the internal reaction cavity of the functional portion of the tubular reactor, in which catalyst particles are provided, creating a venturi effect.

At the funnel portion, the inner passage of the tubular insert decreases in diameter from the first end to the neck portion. The diameter of the inner passage at the first end may be substantially matched to the inner diameter of the reactor tube.

At the functional tube portion, the diameter of the inner passage of the tubular insert gradually increases in the axial direction, from the neck portion to the second end. The diameter of the inner passage at the second end may be substantially matched to the inner diameter of the reactor tube.

The gradual increase in diameter of the inner passage may be any one of: a linear increase, a stepped increase, a parabolic increase, a curved increase or the like.

The length of the reactor internal component may be between 25% and 90% of the length of the reactor tube.

The length of the functional tube portion may be between 25% and 90% of the length of the reactor tube. In particular, the length of the functional tube portion may be between 25% and 50% of the length of the reactor tube.

In one specific example, where the reactor tube has a 50 mm diameter and a 1000 mm height, the tubular insert may have a length of approximately 250 mm and the neck portion of the tubular insert may have a diameter of approximately 25 mm. It is to be appreciated that the dimensions of the tubular insert may be changed to suite a particular reactor tube, and the invention is not limited to these specific dimensions.

In use, the tubular insert may improve temperature distribution by removing heat across a reactor tube wall and reducing the temperature rise in the catalyst bed during an exothermic reaction (e.g. in Fischer-Tropsch Synthesis). In particular, the tubular insert may improve temperature distribution by reducing hot spot formation in the catalyst bed in an exothermic reaction. Advantageously, reducing hot spot formation may prevent catalyst deactivation and/or improving target product selectivity in the catalyst bed.

The reactor internal component may be of a material with good thermal stability. The reactor internal component may be of a material with high thermal conductivity. The material may be in the form of any one of: metal, aluminium, steel, copper, an alloy, corundum, GH3044, metallic oxide, titanium, ceramic, silicon carbide, boron nitride, graphite and graphene, or any other suitable material.

The reactor internal component may be used in conjunction with one or more additional reactor internal components in the reactor tube, in use to prevent the formation of hot spots at local axial positions along the length of the reactor tube.

A modified reactor tube for use in a fixed bed reactor, which includes
a reactor tube having an internal reaction cavity; and
at least one reactor internal component, as described, seated in the internal reaction cavity or forming part of a tubular wall of the reactor tube, which changes a profile of the internal reaction cavity, and decreases a diameter of the internal reaction cavity in at least a portion of the reactor tube, the reactor internal component stabilizing the temperature distribution profile of the reactor tube when the fixed bed reactor is operational.

The fixed bed reactor may be in the form of a multi-tubular fixed bed reactor.

The reactor tube may further include catalyst particles in the internal reaction cavity providing a catalyst bed.

A method of installing a reactor internal component to improve temperature distribution in a reactor tube of a fixed bed reactor, which includes
providing a reactor tube with an internal reaction cavity;
inserting at least one reactor internal component, as described, into a portion of the reactor tube to change a profile of the internal reaction cavity, thereby providing a heat transfer improved internal reaction cavity; and
filling the heat transfer improved internal reaction cavity with catalyst particles to provide a catalyst bed within the fixed bed reactor.

The fixed bed reactor may be in the form of a multi-tubular fixed bed reactor.

The portion of the reactor tube into which the reactor internal component is inserted may be the initial part of the catalyst bed. The neck portion of the reactor internal component may be positioned proximate a top boundary of the catalyst bed. In particular, the reactor internal component may be inserted into a portion of the reactor tube, such that the neck portion is in line with the position where the catalyst bed starts.

The method may include a prior step of removing a layer of ceramic balls (if applied) on the upper side of the catalyst bed.

The method may include the step of removing a volume of catalyst particles to make space for the reactor internal component, before the reactor internal component is inserted.

The reactor internal component may be inserted by axially aligning the internal component with the reactor tube, and sliding the internal component into the inner reaction cavity of the reactor tube.

The step of filling the heat transfer improved internal reaction cavity with catalyst particles to provide a catalyst bed within the fixed bed reactor, may include filling the passage in the functional tube portion, up to the neck portion.

The method may include the final step of reloading the ceramic balls (if applied) above the reactor internal component. This step may include filing the passage in the funnel portion with the ceramic balls, up to the neck portion. As such, the neck portion is positioned at a boundary between the catalyst bed (in the passage of the functional tube portion) and the ceramic ball layer (if applied, in the passage of the funnel portion).

The method may include increasing a length of the catalyst bed in the reactor tube to compensate for the volume of catalyst bed lost due to the volume taken up in the reactor tube by the reactor internal component. This step may include reducing the volume of inert solid particles at ends of the reactor tube.

The invention is now described, by way of non-limiting example, with reference to the accompanying figures:

### FIGURE(S)

In the figure(s):

FIG. 1 shows a design of one example of a reactor internal component;

FIG. 2 shows the reactor internal component shown in FIG. 1 installed in a reactor tube;

FIG. 3 shows three more examples of reactor internal components;

FIG. 4 shows a schematic diagram of axial-cross views of a tubular reactor without (a) and with (b) reactor internals installed;

FIG. 5 shows a temperature contour (a) in the tubular reactor and a comparison (b) of measured and predicted temperatures at different radial positions from the inlet of the tubular reactor;

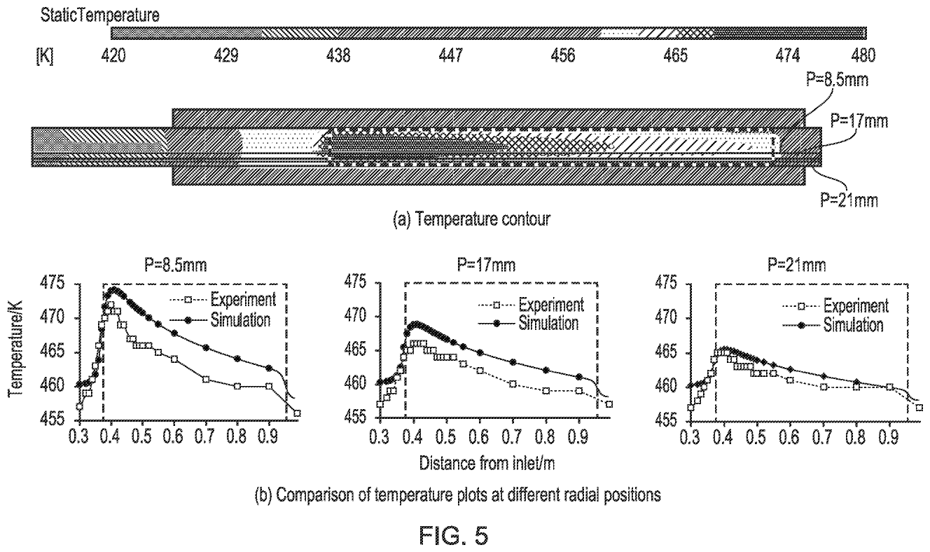

FIG. 6 shows a comparison of CO consumption rates in the centre of the reactor for C1 and C3;

FIG. 7 shows a comparison of temperature contour in the tubular reactors of FIG. 4, without (a) and with (b) reactor internals installed under Fischer-Tropsch synthesis conditions; and

FIG. 8 shows a graph of axial temperature distribution in the tubular reactors of FIG. 4, without (blue) and with (red) reactor internals installed.

In the figures, like reference numerals denote like parts of the invention unless otherwise indicated.

### EMBODIMENT OF THE INVENTION

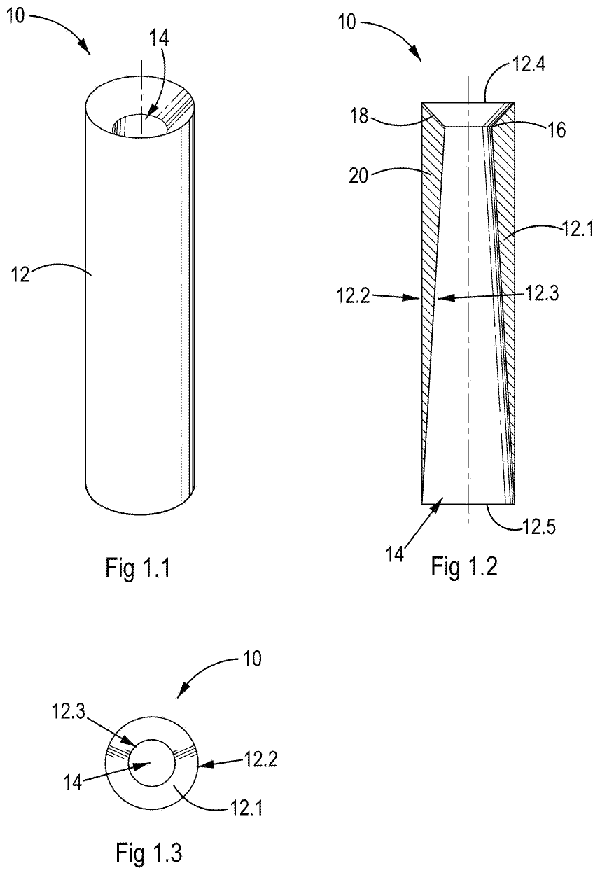

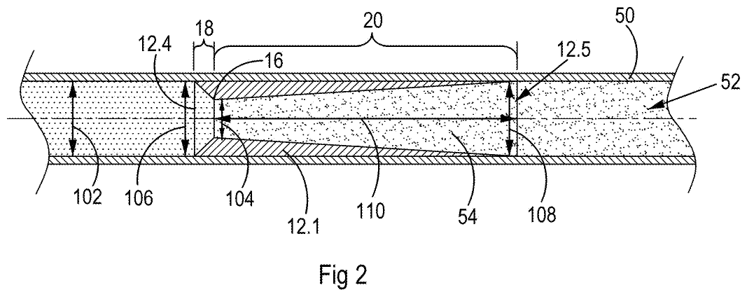

In the figures, reference numeral (10) refers to an example reactor internal component for a tubular fixed bed reactor, in accordance with the invention. The reactor internal component (10) is insertable within a portion of an internal reaction cavity (52) of a reactor tube (50) (see FIG. 2). As shown in FIG. 1, the reactor internal component (10) includes a tubular insert (12), having a tubular wall (12.1) with an outer surface (12.2) shaped and dimensioned to fit into the internal reaction cavity (52) of the reactor tube (50). The tubular insert (12) has an inner passage (14) of varied diameter which is operable to change a profile of the internal reaction cavity (52), in use to improve temperature distribution in a catalyst bed (54) provided within the internal reaction cavity (52).

As best shown in FIG. 1.2 on the left-hand side, the diameter of the outer surface (12.2) of the tubular insert (12) is constant throughout the length of the tubular insert (12), is cylindrically shaped, and dimensioned to fit securely into a reactor tube (50). An outer diameter of the tubular insert (12) is therefore matched to the inner diameter (102) of the reactor tube (50) in which it is installed, such that the reactor internal component (12) fits snugly into the reactor tube (50). The tubular insert (12) has an inner surface (12.3) with a diameter smaller than the inner diameter (102) of the reactor tube (50). The tubular wall (12.1) is of varying thickness to provide the varied diameter of the inner passage (14). In the example shown in FIG. 2, the reactor internal component (10) changes the profile (shape and dimension) of a portion of the cylindrical internal reaction cavity (52) to a conical frustum cavity.

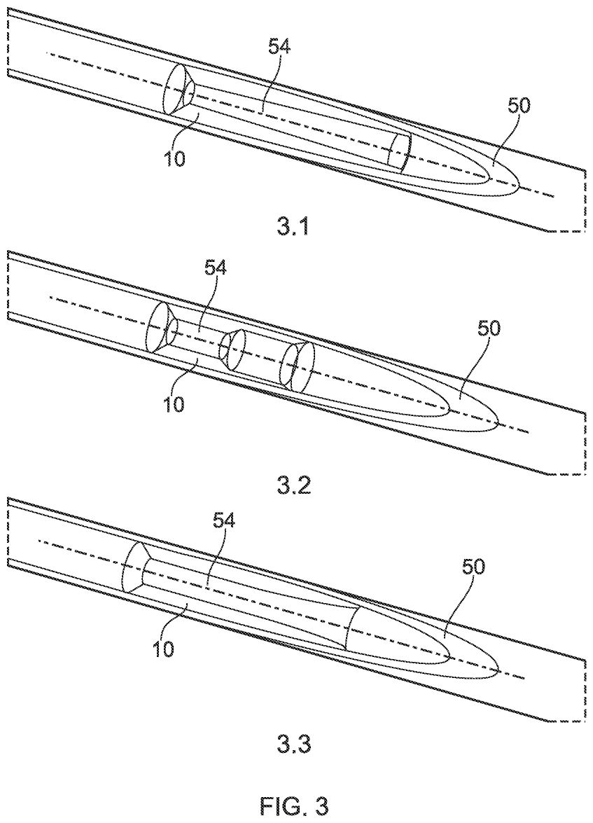

FIG. 3 shows three different examples of reactor internal components (10) in accordance with the invention. It is to be appreciated that the design of the reactor internal component (10) is not limited in these examples. As can be seen in these figures, the change in the profile of the internal reaction cavity (52) includes decreasing the internal diameter of the internal reaction cavity (52) in at least a portion of the reactor tube (50). The reactor internal components (10) are operable to narrow the passage (internal reaction cavity (52)) in the reactor tube (50), thereby decreasing heat build-up and resulting in more heat being removed when an exothermic reaction (e.g. Fischer-Tropsch Synthesis) takes place in the reactor. As shown in FIG. 2, the internal reaction cavity (52) receives catalyst particles which provides the catalyst bed (54). By decreasing the internal diameter of the internal reaction cavity (52), the amount of catalyst particles receivable in that section of the reactor tube (50) decreases and the heat transfer is intensified.

The reactor internal component (10) is axially receivable within the reactor tube (50), as shown in FIG. 2. In particular, the tubular insert (12) is placed at an upstream section (inlet, initial, entrance) of the catalyst bed in the reactor tube (50). Advantageously, this upstream section is the portion of the reactor tube (50) which is prone to hot spot formation, and in use, the tubular insert (12) reduces the temperature increase at that position.

As shown in FIGS. 1.2 and 2, the reactor internal component (10) has two ends, a first end (12.4) positioned before a second end (12.5), relative to the direction of flow in the tubular fixed bed tubular reactor, such that the flow is from the first end (12.4) to the second end (12.5). In use in a reactor, the first end (12.4) is positioned above the second end (12.5).

The tubular insert (12) has a neck portion (16) positioned between the two ends (12.4, 12.5). The neck portion (16) is defined where the inner diameter (104) of the inner passage (14) is the smallest and the tubular wall (12.1) is at its thickest. The inner diameter (104) at the neck portion (16) is between 10% and 90% of the diameter (102) of the reactor tube (50), preferably between 30% and 50%. In this example, the inner diameter (106) at the neck portion (16) is 50% of the diameter (102) of the reactor tube (50).

The neck portion (16) separates the tubular insert (12) into a funnel portion (18) and a functional tube portion (20). The funnel portion (18) is defined by a section of the tubular insert (12) between the first end (12.4) and the neck portion (16). The functional tube portion (20) is defined by a section of tubular insert (12) between the neck portion (16) and the second end (12.5).

The funnel portion (18) functions as a draft tube for gaseous reactants which affects the flow dynamics and pressure drop of the catalyst bed (54). The funnel portion (18) forms a constriction between the internal reaction cavity (52) proximate a first end (12.4) of the tubular insert (12) in which a ceramic ball layer is disposed, and the internal reaction cavity (52) at the functional portion (20) of the tubular insert (12) in which catalyst particles are provided, creating a venturi effect. At the funnel portion (18), the inner passage (14) of the tubular insert (12) decreases in diameter from the first end (12.4) to the neck portion (16). As best shown in FIG. 2, the diameter (106) of the inner passage (14) at the first end (12.4) is substantially matched to the inner diameter (102) of the reactor tube (50). To achieve this, the tubular wall (12.1) increases in thickness from the first end (12.4) to the neck portion (16).

At the functional tube portion (20), the diameter of the inner passage (14) of the tubular insert (12) gradually increases in the axial direction, from the neck portion (16) to the second end (12.5). The diameter (108) of the inner passage (14) at the second end (12.5) is substantially matched to the inner diameter (102) of the reactor tube (50). To achieve this, the tubular wall (12.1) decreases in thickness from the neck portion (16) to the second end (12.5). The axial length (110) of the functional tube portion (20) is between 25% and 100% of the length of the reactor tube (50). In this example, the axial length (110) of the functional tube portion (20) is 33% of the length of the reactor tube (50). It is to be appreciated that this reflects only one example of axial length (110) and other lengths of the functional tube portion (20) can be used depending on the reactor tube (50) length.

In the example shown in FIG. 2, the reactor tube (50) has a 50 mm diameter (102) and a 1000 mm height, and the tubular insert (12) has a length of 251 mm and the neck portion (16) of the tubular insert (12) has a diameter (104) of 25 mm. Again, this is only one example of the dimensions of the tubular insert (12) which can differ depending on the dimensions of the reactor tube (50).

FIG. 3 shows another three examples of the reactor internal component (10). The type or shape of the gradual increase in diameter of the inner passage (14) in these examples is a linear increase (FIG. 3.1), a stepped increase (FIG. 3.2), and a parabolic increase (FIG. 3.3), respectively.

The reactor internal component (10) is of a material with good thermal stability and high thermal conductivity. In these examples, the material is selected as copper. In use, the reactor internal component (10) improves temperature distribution in the catalyst bed (54) during an exothermic reaction.

An example of the design and evaluation which led to the present invention follows, with a condensed description of the outcome thereunder.

### Full Study: Design and Evaluation

Design of ring and tube type internals:

Since the concentration of reactants decreases in the direction of flow in a fixed bed reactor, the reaction rate is relatively high at the entrance to the catalyst bed. Higher reaction rates result in an increased rate of release of reaction heat which in turn, increases the local temperature and consequently accelerates the reaction rate. Usually a hot spot firstly forms in the initial part of the catalyst bed, because the rate of reaction heat release exceeds the heat removal capacity of reactor.^{2, 23}

Reactor internal components were designed to be placed in the inlet section of the catalyst bed, so as to partially change the effective inner diameter of the bed along the axial direction. FIG. 1 is a drawing of the assembled reactor internal component, while FIG. 2 shows the axial section view. As can be seen in FIGS. 1 and 2, the proposed reactor internal component comprises a ring & tube type structure, with the outer diameter designed to fit perfectly into the inside of the reactor tube (shown best in FIG. 2), while the inner diameter varies in the axial direction. The neck position, where the inner diameter is the smallest, is at the top boundary of the catalyst bed and divides the internals into two parts, namely: the outer part (funnel portion) which works as a draft tube for the gaseous reactants; and the inner part (functional portion) which is the functional part. The configurations of the “draft tube” part, affects the flow dynamics and pressure drop. In the functional portion, the inner diameter increases linearly in the axial direction, which means that the effective reactor tube diameter is adjusted. Since the desired characteristics of the reactor internal component should include: good thermal stability, high thermal conductivity, and being cost-effective and easy to manufacture, the available material for manufacturing can be copper (which was used in the simulation), aluminum, steel, titanium, metallic oxide, steel, alloy, corundum, GH3044 alloy. Nonmetal materials can also be used, including ceramics, silicon carbide, boron nitride, graphite and graphene.

FIG. 2 also shows that it is easy to assemble the reactor internal component (or “internals”). The process is: firstly remove the layer of ceramic ball on the upper side of the catalyst bed (if applicable); remove a volume of catalyst particles equal to the volume of the cavity of the conical frustum of the internals; insert the internals inside the tube; lastly, fill the internal cavity with catalyst particles and re-load the ceramic balls (if used) above the insert. Obviously, if it is required to keep the total volume of catalyst in the reactor tube constant, the total length of the catalyst bed will be longer after the internals are installed. However, given that both ends of the catalyst bed are normally packed with inert solid particles, there is typically some flexibility to pack the reactor tube fully, and the required increase in catalyst bed height should be containable. Thus, no additional modification to the original reactor or additional operational procedures are needed to install the internals.

As shown in FIG. 2, the effective inner diameter of the reactor tube is directly influenced by the neck diameter (D_{neck}); while its rate of increase is dependent on the length of the cavity of the conical frustum (h). In order to compare reaction performance with and without the internals, the total amount of catalyst loaded should be maintained, i.e. the volume of the cavity of the conical frustum should be equal to the volume of replaced cylindrical shaped catalyst bed. The equations describing the volume of the cavity of the conical frustum (Equation 1) and the volume of cylinder (Equations 2) are as follows:

$${V}_{con} = \frac{1}{3} π h ( {D}_{neck}^{2} + {R}^{2} + {D}_{neck} R ) \qquad ( 1 )$$

$${V}_{cyl} = π {R}^{2} H \qquad ( 2 )$$

Where V_{con} and V_{cyl} represent the volume of the cavity of the conical frustum and the cylinder respectively, mm³; H is the length of the replaced cylindrically shaped catalyst bed, mm; and R is the inner diameter of the reactor tube, mm. The length of the cavity of the conical frustum cavity height h is greater than H, because the total amount of catalyst is kept as constant, namely V_{con}=V_{cyl}. It is more convenient to use the volumetric proportion of the replaced cylindrically shaped catalyst bed v as the configuration variable of the reactor internals. Since both the h or H are proportional to V_{cyl}, the configuration of either the conical frustum cavity or the replaced cylindrically shaped catalyst bed can be determined in terms of the same variable. The proportion v was varied from 15% to 25% in this study for the design of the internals. The values of the variables used for the different simulations (C1 to C6) are summarized in Table 1 below. In the table, C1 indicates the blank case, in which no ring & tube type internals were used.

TABLE 1
Summary of specifications for the different simulations

| NO. | C1 | C2 | C3 | C4 | C5 | C6 |
|---|---|---|---|---|---|---|
| v/% | — | 20 | 20 | 20 | 15 | 25 |
| a/mm | — | 13 | 25 | 38 | 25 | 25 |
| h/mm | — | 264 | 201 | 150 | 150 | 251 |

Note:
v represents the conical frustum cavity volume proportion of the total catalyst bed.

Reactor model and validation:
Reactor model:

The reactor model was built based on a practical bench scale TFBR which was 50 mm in diameter and 1000 mm in height. Its geometry is shown in FIG. 1, and it can be seen that it consists of two parts: a catalyst bed on the tube side; and an annular oil bath on the shell side. When simulating the reactor with the reactor internal components installed, only the geometry of the model was changed. FIG. 2 shows a schematic of the reactor model with internals installed. The individual geometry is different for C2 to C6, since the specifications for the internals is different in each case, but the configuration of the reactor was kept constant. Assuming the mean bed void is constant, three solid porous zones were considered, namely a ceramic ball layer, the catalyst bed, and another layer of ceramic balls.³¹ The physical properties of the ceramic ball layers and the catalyst bed are listed in Table 2 below.

Reynolds number for flow in the bed indicated that the flow is laminar, hence a laminar flow model was applied. The boundary between the reaction region and the oil bath region was set as a coupled wall, so that the corresponding heat transfer coefficients at different axial positions could be calculated based on the local fluid properties. The other walls adjacent to the atmosphere were set as adiabatic walls, since the experimental apparatus was covered by a layer of insulating material. The simulation software calculated the built-in governing equations, including the Navier-Stokes equation, energy balance, species balances, etc., in each individual cell of the model.^{32 33} The SIMPLE algorithm was chosen for the Pressure-Velocity Couple scheme. The simulation results were regarded as convergent only when the calculated residuals were smaller than the absolute criterion of 10⁻⁶.

TABLE 2
Physical properties of the ceramic ball layer and the catalyst bed

| | Ceramic ball | Catalyst |
|---|---|---|
| Diameter/mm | 3.6 ± 0.3 | 1.8 ± 0.2 |
| Thermal conductivity/(W · m⁻¹ · K⁻¹) | 1.2 | 1.4 |
| Pecking density/(g · ml⁻¹) | 1.35 | 0.69 |
| Bed void/% | 46 | 62 |

For a Co-supported catalyst FTS system, side reactions (for example the water gas shift reaction), can be neglected. The FTS products were assumed to be only alkanes, and methane and ethane were used to represent the C₁ and C₂ product respectively. Because the formation rates of the C₃₊ products (hydrocarbons with carbon number bigger than 3) are dependent on the C₂ product and chain growth probability, it is acceptable to use pentane to represent the C₃₊ products, for the purpose of simplifying the reaction kinetics. All the reactants and products are considered to be in the gas phase. The semi-empirical kinetics employed in this investigation were the same as that used in the previous study.^{34 35} The reaction scheme is summarized in Table 3 below, and the equations for the CO consumption rate (Equation 4) and product formation rates are listed in Equations 5-7.

TABLE 3
FTS reaction scheme

| | Reaction |
|---|---|
| R₁ | CO + 3H₂ ↔ CH₄ + H₂O |
| R₂ | 2CO + 5H₂ ↔ C₂H₆ + 2H₂O |
| R₃ | 5CO + 11H₂ ↔ C₅H₁₂ + 5H₂O |

r_{FT}=k₁·exp(−E₁/RT)·C_{CO}·C_{H}_{₂}/(1+k₂·exp(−E₂/RT)·C_{CO})² (3)

r_{CO}=−r_{FT} (4)

r_{C}_{₁}=k₃·exp(−E₃/RT)·r_{FT} (5)

r_{C}_{₂}=k₄·exp(−E₄/RT)·r_{FT} (6)

r_{C}_{₃₊}=[1−k₃·exp((−E₃/RT)−2×k₄·exp(−E₄/RT)]·r_{FT}/5 (7)

Where r_{FT} is the FTS reaction rate, kmol/(m³·s); r_{CO} is the CO consumption rate, kmol/(m³·s); r_{C}_{₁}, r_{C}_{₂} and r_{C}_{₃₊} are the formation rates of methane, ethane and pentane, respectively; C_{CO} and C_{H}_{₂} are the concentrations of CO and hydrogen. The mass balance of the model was checked, and the values of the eight constant coefficients used in the model are listed in Table 4 below. The four pre-exponential factors (k₁-k₄) were adjusted according to the FTS experimental results, while the activation energies (E₁-E₄) are taken from the literature^{36 37 38}.

TABLE 4
List of kinetics parameters used in this study

| | k₁ | k₂ | k₃ | k₄ | E₁(kJ/mol) | E₂(kJ/mol) | E₃(kJ/mol) | E₄(kJ/mol) |
|---|---|---|---|---|---|---|---|---|
| parameters | 4.94 × 10⁹ | 4.68 | 8.58 × 10⁷ | 1.08 × 10³ | 100 | 20 | 81 | 49 |

All the simulations were conducted under the same conditions, namely: 1200 ml of combined catalyst and ceramic (made up of 300 ml 15% Co—SiO₂ catalyst and the balance being ceramic balls); 458 K operating temperature; 20 bar operating pressure; flowrate of 1.5 Nl/min reactant mixture (H₂/CO=2).

Model validation:

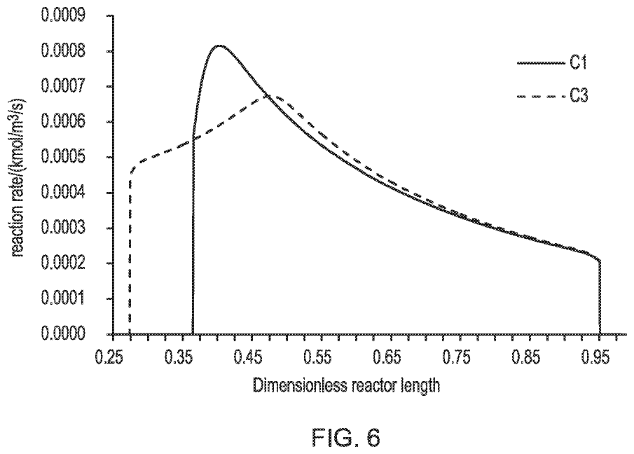

The model validation was done by comparing the simulation results obtained from the blank case (C1) to the experimental results. The comparison of the CO conversion and product selectivity are given in Table 5 below. As can be seen, the relative error in the CO conversion is only 8.5%, and the predicted selectivity is even more accurate, therefore it is concluded that the reaction kinetics are reliable and are suitable for describing the actual FTS reaction. More importantly, the heat transfer behaviour in the catalyst bed was also validated by comparing the predicted and measured temperature profiles. A specially designed temperature measurement system was implemented in the experiment set-up where axial temperature was measured at different radial position in the reactor, corresponding to radii of 8.5 mm, 17 mm and 21 mm respectively. FIG. 6(a) shows the predicted temperature contour in the reactor. The position of the catalyst bed is denoted by the region inside the dashed-lines, and the positions of the thermocouple are also indicated (P=8.5 mm; P=17 mm; P=21 mm). The comparison of the experimental and the predicted temperature profiles, at corresponding positions, are shown in FIG. 6(b). The maximum mean absolute error of all the temperature data is only 3.2 K, which is considered acceptable when compared to the operating temperature of 458 K. Thus, it is reasonable to assume that the heat transfer behaviour is well described. As mentioned above, only the geometry changes in the different simulation cases C2 to C6, and the inventors believe that the use of the reactor internals does not affect the simulation methodology. Therefore, the inventors claim that the simulations described in this study are reliable.

TABLE 5
Comparison of experimental results and
simulation data for the blank case (C1)

| | Experimental | Simulation | Relative |
|---|---|---|---|
| | result | data | error/% |
| CO conversion/% | 48.3 | 52.4 | −8.5 |
| S_{CH4}/% | 7.04 | 6.93 | 1.56 |
| S_{C2}/% | 0.68 | 0.68 | 0 |
| S_{C3+}/% | 92.3 | 91.7 | 0.61 |

Results and discussion:

Predicted performance of internals of different geometries:

Various neck diameter and frustum cavity height options were investigated ceteris paribus. The simulation results are summarized in Table 6 and Table 7 below. In order to evaluate the performance of different reactor internal components, the rate of change (R) is defined as:

R=(Aᵢₙₜ−A_{org})/A_{org}×100% (8)

Where: A can be maximum temperature increase ΔT_{MAX}, CO conversion X_{CO}, selectivity of methane S_{C1} or selectivity of C₃₊ products S_{C3+}—depending on its use; the subscripts org and int indicate whether the parameter A refers to the original (org) tubular reactor (also known as the blank case C1) or the tubular reactor with the reactor internal component internals (int) installed (C2 to C6) respectively; A negative value of R indicates that the parameter decreases when reactor internal components are used.

A comprehensive comparison of the simulation results for the blank case (C1) to those with reactor internal components installed (C2 to C6) is given in Tables 6 and 7. These show that: the ΔT_{MAX} in C2 to C6 dropped as the R is negative, reaching as low as −22.6% in C6; the CO conversion was almost constant as the rate of change is no more than 2.1%. Thus, we can conclude that: the temperature rise was inhibited by applying the reactor internal components; while the CO conversion was not significantly affected; the average temperature of the catalyst bed (T_{AVE}) decreased in the case of C2-C6; the methane selectivity declined slightly; S_{C3+} increased compared to C1.

Table 6 shows that when increasing the neck diameter from 13 to 38mm, both ΔT_{MAX} and T_{AVE} showed a minimum. The lowest value of ΔT_{MAX} was obtained in case C3 with D_{neck} of 25mm. The reaction performance of FTS is directly related to the temperature of the catalyst bed, thus S_{C1} increased with increasing T_{AVE}, while S_{C3+} showed the opposite trend. In addition, although the values of R_{XCO} R_{SC1} and R_{SC3+} were quite small, the changes were obvious when decreasing D_{neck} from 38 mm to 25 mm. This means that the FTS results were more sensitive in this range.

TABLE 6
The performance of internals with different neck diameters

| | original | internals | | |
|---|---|---|---|---|
| NO. | C1 | C2 | C3 | C4 |
| D_{neck}/mm | — | 13 | 25 | 38 |
| ΔT_{MAX}/K | 16.9 | 14.5 | 14.0 | 14.7 |
| R_{ΔTmax}/% | — | −14.1 | −16.9 | −12.8 |
| T_{AVE}/K | 463.4 | 463.2 | 463.1 | 463.4 |
| X_{CO}/% | 51.8 | 51.2 | 51.1 | 51.7 |
| R_{Xco}/% | — | −1.19 | −1.34 | −0.12 |
| S_{C1}/% | 6.83 | 6.58 | 6.55 | 6.74 |
| R_{SC1}/% | — | −3.65 | −4.09 | −1.35 |
| S_{C3+}/% | 92.5 | 92.8 | 92.7 | 92.6 |
| R_{SC3+}/% | — | 0.29 | 0.25 | 0.10 |

TABLE 7
The performance of internals with different
proportions of catalyst being replaced

| | original | internals | | |
|---|---|---|---|---|
| NO. | C1 | C5 | C3 | C6 |
| v/% | — | 15 | 20 | 25 |
| ΔT_{MAX}/K | 16.9 | 14.8 | 14.0 | 13.1 |
| R_{ΔTmax}/% | — | −12.3 | −16.9 | −22.6 |
| Tave/K | 463.4 | 463.2 | 463.1 | 462.9 |
| X_{CO}/% | 51.8 | 51.3 | 51.1 | 50.7 |
| R_{Xco}/% | — | −0.99 | −1.34 | −2.13 |
| S_{C1}/% | 6.83 | 6.63 | 6.55 | 6.46 |
| R_{SC1}/% | — | −3.03 | −4.09 | −5.41 |
| S_{C3+}/% | 92.5 | 92.6 | 92.7 | 93.0 |
| R_{SC3+}/% | — | 0.20 | 0.25 | 0.48 |

As indicated in Table 7, T_{AVE} declined gradually as the proportion of the original cylinder shape catalyst bed was changed from 15% to 25%, while the ΔT_{MAX} dropped as low as 13.1 K with the change in rate of −22.6% for C6. The results demonstrate that a longer frustum cavity results in a lower peak temperature within the catalyst, as well as better product distribution for longer chain hydrocarbons. Furthermore, the methane selectivity decreased from 6.63% to 6.46%, while the C₃₊ products selectivity rose slightly from 92.6% to 93.0% (see Table 7). However, the CO conversion correspondingly dropped slightly from 51.3% to 50.7% which was caused by the lower average catalyst bed temperature; and the maximum changing rate was only −2.13%.

When the reactor internal component was applied to an existing TFBR, the packed catalyst volume was usually kept constant to maintain the reactor productivity at the same level. Therefore, there were slight increases in the catalyst bed height. The total height of the catalyst bed (H) in the different cases and their corresponding rate of change for each (R_{H}) are listed in Table 8. We can see that H increased with decreasing neck diameter D_{neck} or when enlarging the proportion of replaced original cylinder shape catalyst bed (v). Normally, there is extra space at both ends of the catalyst bed for the layers of inert solid supports. Thus, the fixed bed reactor may be designed to 1.5 times longer at most than its catalyst bed. However, actual TFBR design varies from case to case, and the available extra space in TFBR for the application of the reactor internal components cannot be determined in general. For example, in this experiment setup, inserting the reactor internal component increased the bed height by 20% of the total catalyst bed height at most, which is acceptable.

TABLE 8
Summary of the total catalyst height (H) in different cases
and the corresponding rate of change (R_{H}) in different cases

| NO. | C1 | C2 | C3 | C4 | C5 | C6 |
|---|---|---|---|---|---|---|
| H/mm | 585 | 732 | 669 | 618 | 647 | 690 |
| R_{H}/% | — | 25.1 | 14.4 | 5.6 | 10.6 | 17.9 |

The results suggest that, when designing reactor internal component for a new tubular reactor or when modifying an existing reactor, the neck diameter D_{neck} should be optimized; and while a bigger proportion of replaced original cylinder catalyst bed is preferred, the actual value should be determined according to the available tube length.

### Mechanism:

There are two mechanisms that reduce the maximum temperature when using the reactor internal components. The simulation results for C1 and C3 can be used as examples for comparison and the axial CO consumption rate along the centre of the catalyst bed in C1 and C3 is shown in FIG. 6. On the one hand, the reactor internal components increase the heat removal capacity by partially reducing the effective reactor diameter. Comparing the temperature increase in the thermal oil between the inlet and the outlet in C1 and C3 supports that there is increased heat removal (see Table 9). The initial inlet temperature for the thermal oil is the same in both cases, therefore, a higher temperature in the thermal oil at the outlet indicates that more reaction heat is removed. One can see that the temperature difference increased slightly from 0.0623 K (C1) to 0.0704 K (C3) and thus the internals resulted in more reaction heat being removed, even though the total amount of reaction heat released in C3 is lower than that in C1, since CO conversion in C3 decreased by 1.34%, as shown in Table 7.

TABLE 9
Temperature of thermal conductive oil at inlet
and outlet, and temperature difference

| | C1 | C3 |
|---|---|---|
| T_{inlSt}/K | 458.00 | 458.00 |
| T_{outlSt}/K | 458.06 | 458.07 |
| ΔT/K | 0.0623 | 0.0704 |

On the other hand, the reaction intensity at the “critical” zone was dispersed over a longer axial distance (see FIG. 6) as the original cylindrical shaped catalyst bed (in C1) was replaced with a longer conical shaped bed in C3. It is inevitable that a large amount of heat is released in the FTS process as the reaction is extremely exothermic. An acceptable method to control the temperature of the hot spot is to reduce the rate of release of reaction heat in the initial part of catalyst bed by distributing the reaction heat over a longer axial distance. Although the volume of the cavity of the conical frustum was the same as that of the replaced cylindrical shaped catalyst bed, the catalyst bed packed in C3 had a longer and narrower shape, which means that the reaction rate and the reaction heat release rate per volume of reactor will be lower in the initial part of the catalyst bed, thereby reducing the undesirable temperature rise.

### Conclusions:

In the present invention, a new reactor internal component was developed (ring & tube type internals), to inhibit the hot spot formation in a catalyst bed in FTS. A CFD model showed that modifying a reactor tube with this insert reduced the maximum temperature of the hot spot and improved the selectivity of C3+ products. The reactor model was based on an actual bench-scale TFBR with a 50 mm diameter and 1000 mm length. It was validated by choosing parameters so as to fit both the measured reaction conversions and selectivities. The measured temperature profiles from experiments conducted under typical low temperature FTS conditions with a cobalt catalyst where compared to the predicted profiles, and it was shown that the model predicted both the axial and radial temperature profiles which validated the simulations. By using a blank case (corresponding to no reactor internals) for comparison purposes, it was shown that the internals inhibited hot spot formation in the catalyst bed, while having little effect on the overall FTS reaction rate, i.e.: the maximum temperature in the catalyst bed dropped 22.6% when using internals (Case 6); while the rate of change in CO conversion was less than 2.13%. Furthermore, because of the reduced maximum temperature in the bed, the C₃₊ product selectivity increased slightly when using internals. The effect of the specifications of the internals, namely the diameter at the neck position D_{neck} and conical frustum cavity height h was investigated. For the purposes of comparison, the inventors kept the amount of catalyst used constant in all the simulations and this resulted in the length of the catalyst bed varying for the different cases. The maximum temperature ΔT_{MAX} in the bed showed a minimum with varying diameter of the neck of the insert D_{neck} and an increasing trend with increasing length of cavity of conical frustum h. The overall reaction rate was not very sensitive to the presence of the reactor insert. The internals essentially reduced the effective inner diameter of the reactor tube, which enhanced the heat removal capacity and dispersed the heat release over the hot spot region over a longer axial distance. Given the design of ring & tube type internals, other benefits include ease of manufacturing, simple assembling and disassembling.

### Condensed Results and Outcome

The reactor internal component (or ring and tube type internal), which has a linear increase in diameter in the functional tube portion (as shown in FIG. 3.1), was thus verified in a fixed bed tubular reactor by CFD simulation under typical Fischer-Tropsch synthesis conditions, which is strongly exothermic process. Before testing the internal component, a blank case study, which was without the reactor internal component installed in the reactor tube, was conducted. According to the blank case study, a 2D axisymmetric tubular reactor model with size of 50 mm in diameter and 1000 mm in length was developed by ANSYS Fluent 18.1. The catalyst bed, which was set as a porous zone in this model, was sandwiched by two ceramic ball layers. The Fischer-Tropsch synthesis included a series of reactions as described by a semi-empirical kinetics.^{34 35} The SIMPLE algorithm was chosen for the Pressure-Velocity Couple scheme. Finally, this model in the blank case study was validated, with experiment results obtained under the conditions of: 20 bar, 458 K, Co-based catalyst, 300 ml catalyst, space velocity=300 h-1 and CO/H₂ ratio is 2.

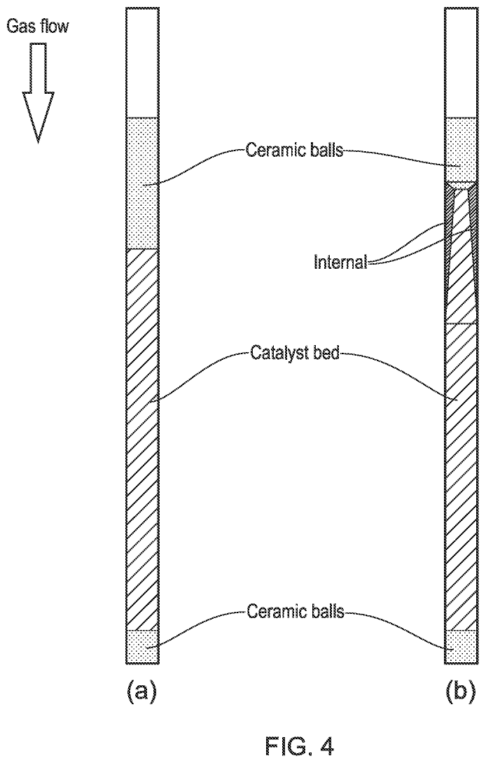

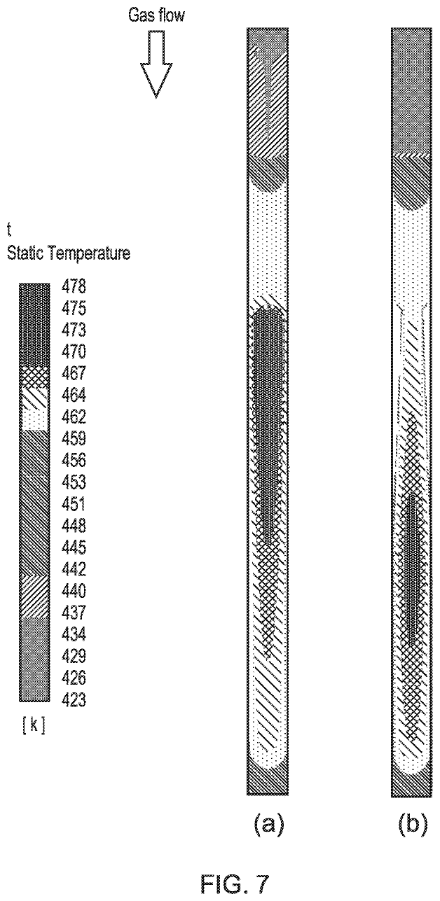

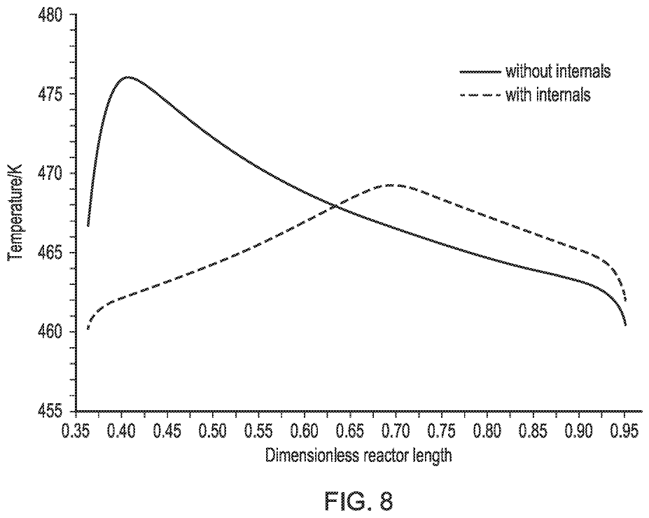

For the test of the reactor internal component, only the model geometry where an example internals was applied was changed while keeping the other parameters the same. FIG. 4 shows the schematic diagram of axial-cross views of a tubular reactor with (b) and without (a) reactor internals installed. As previously mentioned, the specifications of this example of the internals included: 25 mm in neck diameter and 330 mm in functional portion length, with the inner diameter of the internal reaction cavity changing in a linear manner. The simulation results are shown and compared in FIGS. 7 and 8, as well as Table 10 below. In particular, FIG. 7 shows a comparison of the temperature contours along the reactor tube with and without reactor internals. FIG. 8 compares the temperature plots of the reactor tube with and without internals. Table 10 below provides a comparison of the simulation results from tubular reactors with and without internals installed in a Fischer-Tropsch synthesis reaction, including the maximum temperature in the catalyst bed (T_{MAX}/K), the maximum temperature rise (ΔT/K), the change rate of maximum temperature rise comparing to the blank case (change rate/%) and the CO conversion (X_{CO} %).

TABLE 10
Comparison of simulation results from tubular reactors with
and without internals installed in Fischer-Tropsch synthesis

| | | | change | |
|---|---|---|---|---|
| | T_{MAX}/K | ΔT/K | rate/% | X_{CO} % |
| Without internals | 476.1 | 18.1 | | 52.0 |
| With internals | 469.3 | 11.3 | −22.6 | 50.7 |

300 ml Co-based catalyst, 20 bar, 458K, CO/H₂ = 2, space velocity = 300 h⁻¹

It is evident that the temperature rise in the catalyst bed can be improved. In particular, as shown, using the reactor internals can reduce the change rate of maximum temperature rise to as low as 22.6%, whilst simultaneously reducing the CO conversion slightly.

The inventor therefore believes that the present invention provides a novel tubular reactor internal component design which increases the heat transfer capacity across the tubular reactor wall, facilitating heat removal during highly exothermic reactions (e.g. FTS process) and reducing the temperature gradient in the catalyst bed. This allows for the maintenance of isothermal operation, preventing catalyst deactivation and increasing product selectivity. The reactor internal component design presents the further benefits of not substantially increasing the mass of the tubular reactor, and not causing a loss of volumetric efficiency of the tubular reactor, meaning that the reactor performance is not sacrificed. Advantageously, the present tubular reactor internal design can also be used directly and easily in existing TFBR applications. The invention further provides a reactor tube with such reactor internal components and a method of assembling same.

1. A reactor internal component for a fixed bed reactor, axially receivable within a portion of an internal reaction cavity of a reactor tube, which includes
a tubular insert, having a tubular wall with an outer surface shaped and dimensioned to fit into the internal reaction cavity of the reactor tube, the tubular insert having an inner passage of varied diameter which is operable to change a profile of the internal reaction cavity, the tubular insert has two ends, a first end operable to be positioned before a second end, relative to the direction of flow in the fixed bed tubular reactor, such that the flow is from the first end to the second end, the tubular insert having a neck portion positioned between the two ends, defined where an inner diameter of the inner passage is the smallest, the neck portion separates the tubular insert into a funnel portion and a functional tube portion, the funnel portion is defined by a section of the tubular insert between the first end and the neck portion and the functional tube portion is defined by a section of tubular insert between the neck portion and the second end, at the functional tube portion, the inner passage of the tubular insert gradually increases in diameter in an axial direction, from the neck portion to the second end.

2. The reactor internal component as claimed in claim 1, in which a diameter of the outer surface of the tubular insert is constant throughout the length of the tubular insert, with the tubular wall being of varying thickness to provide the varied diameter of the inner passage.

3. The reactor internal component as claimed in claim 1, in which the change in the profile of the internal reaction cavity includes decreasing an internal diameter of the internal reaction cavity in at least a portion of the reactor tube.

4. The reactor internal component as claimed in claim 1, in which an outer diameter of the tubular insert either: matches or is slightly less than an internal diameter of the reactor tube in which it is to be installed, such that the reactor internal component fits snugly into the reactor tube.

5. The reactor internal component as claimed in claim 1, in which, at the funnel portion, the inner passage of the tubular insert decreases in diameter in an axial direction from the first end to the neck portion, the funnel portion operable to function as a draft tube for gaseous reactants.

6. The reactor internal component as claimed in claim 1, in which the gradual increase in diameter of the inner passage in the functional tube portion is selected from any one or more: a linear increase, a stepped increase, a parabolic increase and a curved increase.

7. The reactor internal component as claimed in claim 1, in which the inner diameter at the neck portion is between 10% and 90% of the inner diameter of the reactor tube.

8. The reactor internal component as claimed in claim 1, in which the inner diameter at the neck portion is between 30% and 50% of the inner diameter of the reactor tube.

9. The reactor internal component as claimed in claim 1, in which the length of the reactor internal component is between 25% and 90% of the length of the reactor tube.

10. The reactor internal component as claimed in claim 1, in which the length of the functional tube portion is between 25% and 50% of the length of the reactor tube.

11. The reactor internal component as claimed in claim 1, in which the inner passage in the functional tube portion of the tubular insert is frustum shaped, which is operable to change the profile of the internal reaction cavity, which is normally cylindrical, to a frustum cavity.

12. The reactor internal component as claimed in claim 1, in which the reactor internal component is of a material with good thermal stability and high thermal conductivity, selected from any one of: metal, aluminium, steel, copper, an alloy, corundum, GH3044, metallic oxide, titanium, ceramic, silicon carbide, boron nitride, graphite and graphene.

13. A modified reactor tube for use in a fixed bed reactor, which includes
a reactor tube having a cylindrical internal reaction cavity; and
at least one reactor internal component, as claimed in claim 1, seated in the internal reaction cavity or forming part of a tubular wall of the reactor tube, which changes a profile of the internal reaction cavity, and decreases a diameter of the internal reaction cavity in at least a portion of the reactor tube, the at least one reactor internal component stabilizing the temperature distribution profile of the reactor tube when the fixed bed reactor is operational.

14. The modified reactor tube as claimed in claim 13, which includes catalyst particles in the internal reaction cavity providing a catalyst bed.

15. The modified reactor tube as claimed in claim 14, in which the at least one reactor internal component is located at an upstream section of the catalyst bed in the reactor tube.

16. The modified reactor tube as claimed in claim 15, in which the at least one reactor internal component is located such that the neck is positioned at the start of the catalyst bed.

17. A method of installing a reactor internal component to improve temperature distribution in a reactor tube of a fixed bed reactor, which includes
providing a reactor tube with an internal reaction cavity;
inserting at least one reactor internal component, as claimed in claim 1, into a portion of the reactor tube to change a profile of the internal reaction cavity, thereby providing a heat transfer improved internal reaction cavity; and
filling the heat transfer improved internal reaction cavity with catalyst particles to provide a catalyst bed within the reactor tube.

18. The method as claimed in claim 17, which includes a prior step of removing a layer of ceramic balls on the upper side of the catalyst bed, and then removing a volume of catalyst particles to make space for the reactor internal component, before the reactor internal component is inserted.

19. The method as claimed in claim 17, in which the reactor internal component is inserted by axially aligning the internal component with the reactor tube, and sliding the internal component into the inner reaction cavity of the reactor tube.

20. The method as claimed in claim 17, in which the portion of the reactor tube into which the reactor internal component is inserted is proximate a top boundary of the catalyst bed.

21. The method as claimed in claim 18, which includes the later step of reloading the ceramic balls above the reactor internal component.

22. The method as claimed in claim 17, which includes increasing the length of the catalyst bed in the reactor tube, by reducing the volume of inert solid particles at ends of the reactor tube and replacing the volume with catalyst particles, to compensate for the volume of catalyst bed lost due to the volume taken up in the reactor tube by the reactor internal component.
